(19) United States
(12) Patent Application Publication
(10) Pub. No.: US 2026/0056900 A1
(43) Pub. Date: Feb. 26, 2026

(54) MOTHERBOARD DEVICE AND METHOD FOR DETECTING ADD-IN CARD OF MOTHERBOARD DEVICE

(71) Applicant: WISTRON CORPORATION, New Taipei City (TW)

(72) Inventors: Mao Wen WENG, New Taipei City (TW); Yung Chi SUNG, New Taipei City (TW)

(73) Assignee: WISTRON CORPORATION, New Taipei City (TW)

(21) Appl. No.: 18/935,837

(22) Filed: Nov. 4, 2024

(30) Foreign Application Priority Data
Aug. 21, 2024 (TW) 113131481

(51) Int. Cl. G06F 13/40; G06F 13/42

(52) U.S. Cl. CPC G06F 13/4022; G06F 13/409; G06F 13/423

(57) ABSTRACT

A motherboard device and a method for detecting an add-in card of the motherboard device are provided. The motherboard device includes a bus slot, a switching circuit, and a controller. The bus slot includes a first pin terminal and a second pin terminal. The switching circuit includes a first terminal, a second terminal, a third terminal, and a control terminal. The first terminal is coupled to the first pin terminal, the second terminal is coupled to the second pin terminal, and the third terminal is coupled to the first terminal and to a clock enable terminal. The controller provides a control signal to the control terminal according to detection information of the bus slot to selectively connect the third terminal to the first terminal or to the second terminal in the switching circuit.

### CROSS-REFERENCE TO RELATED APPLICATION

This application claims the priority and benefit of Taiwan Application No. 113131481, filed on Aug. 21, 2024, the disclosure of which is hereby incorporated in its entirety by reference herein.

### TECHNICAL FIELD

The disclosure relates to a bus technique applied to a computer system, and in particular to a motherboard device and a method for detecting an add-in card of the motherboard device.

### BACKGROUND

### Related Art

The Peripheral Component Interconnect Express (PCIe) bus is a bus technique standard commonly used in computer systems allowing computing components (such as processors, chipsets, caches, memory, add-in cards, graphics cards, and storage devices) to communicate with each other. As technology continues to evolve, a plurality of versions of the PCIe bus have been launched, and corresponding specifications have been developed for different types of computing components (such as graphics cards). Currently, PCIe 3.0 and PCIe 4.0 versions are the mainstream PCIe bus standards currently used on graphics cards.

However, PCIe 3.0 version (including earlier versions) and PCIe 4.0 version (including newer versions) have some functional conflicts in the pin definitions of the graphics card. In other words, the PCIe bus may be incompatible with each other in terms of functional implementation of specific pins.

### SUMMARY

The disclosure provides a motherboard device and a method for detecting an add-in card, so that a computer device may smoothly support different types of bus add-in cards.

A motherboard device of an embodiment of the disclosure includes a bus slot, a switching circuit, and a controller. The bus slot includes a first pin terminal and a second pin terminal. The switching circuit includes a first terminal, a second terminal, a third terminal, and a control terminal. The first terminal is coupled to the first pin terminal, the second terminal is coupled to the second pin terminal, the third terminal is coupled to the first terminal and to a clock enable terminal, and the clock enable terminal is configured to provide a clock enable signal. The controller is coupled to the bus slot and to the control terminal of the switching circuit. The controller is configured to provide a control signal to the control terminal according to detection information of the bus slot to selectively connect the first terminal to the third terminal or connect the second terminal to the third terminal in the switching circuit.

A method for detecting an add-in card of a motherboard device of an embodiment of the disclosure includes: determining detection information of a bus slot, wherein the bus slot includes a first pin terminal and a second pin terminal; providing a corresponding control signal to a control terminal of a switching circuit via a controller according to the detection information, wherein the switching circuit includes a first terminal, a second terminal, a third terminal, and a control terminal, the first terminal is coupled to the first pin terminal, the second terminal is coupled to the second pin terminal, the third terminal is coupled to the first terminal and to a clock enable terminal, wherein the clock enable terminal is configured to provide a clock enable signal; and connecting the first terminal to the third terminal or connecting the second terminal to the third terminal selectively via the switching circuit according to the provided control signal.

### BRIEF DESCRIPTION OF THE DRAWINGS

FIG. 1A and FIG. 1B are schematic diagrams of using a PCIe add-in card of PCIe 3.0 type and using a PCIe add-in card of PCIe 4.0 type respectively according to an embodiment of the disclosure.

FIG. 2 is a block diagram of a computer device according to an embodiment of the disclosure.

FIG. 3A to FIG. 3C are schematic diagrams of the switching circuit and the controller according to the first to third embodiments of the disclosure respectively.

FIG. 4 is a flowchart of a method for detecting an add-in card of a motherboard device according to an embodiment of the disclosure.

FIG. 5 is a timing diagram illustrating based on the signal waveforms in the PCIe specification of the JEDEC Solid State Technology Association according to an embodiment of the disclosure.

FIG. 6 is a diagram of each signal waveform in the detection method according to an embodiment of the disclosure.

### DETAILED DESCRIPTION

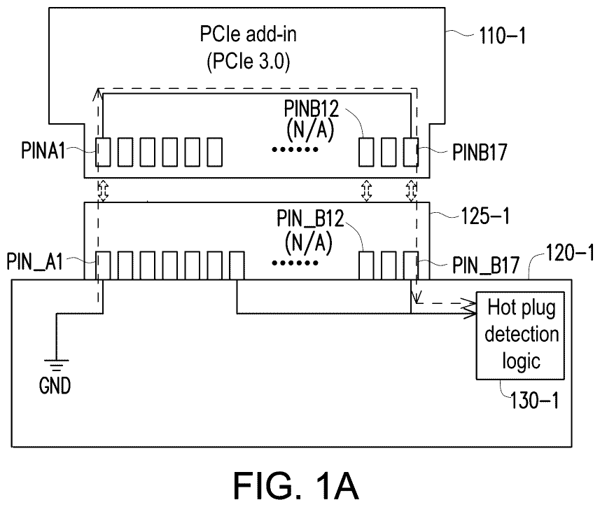

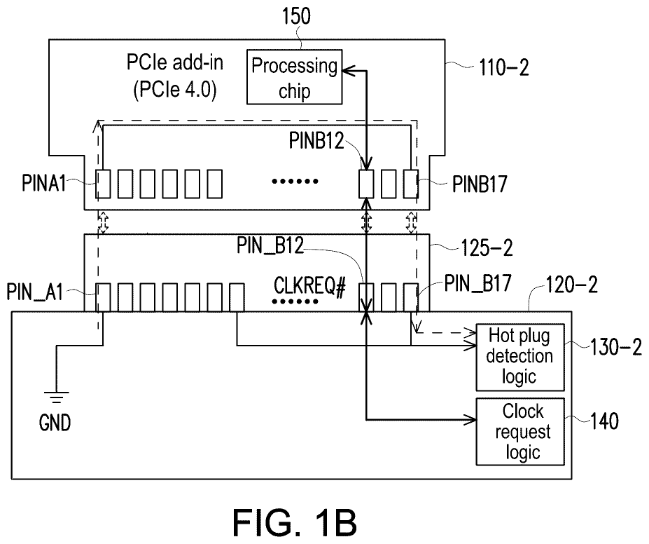

FIG. 1A and FIG. 1B are schematic diagrams of using a PCIe add-in card of PCIe 3.0 type and using a PCIe add-in card of PCIe 4.0 type respectively according to an embodiment of the disclosure. The PCIe add-in card of the present embodiment is a device adopting the PCIe interface specification, such as a display card or other peripheral devices of a computer system. Here, the card type using PCIe 3.0 type technique as a PCIe add-in card is called “a PCIe add-in card of PCIe 3.0 type”, and the card type using PCIe 4.0 type technique as a PCIe add-in card is called “a PCIe add-in card of PCIe 4.0 type”to facilitate subsequent descriptions.

In the present embodiment, “PCIe 3.0 type” refers to the corresponding technique including the PCIe 3.0 specification version and previously disclosed corresponding PCIe specification versions (e.g., PCIe 1.X, PCIe 2.X, etc.) “PCIe 4.0 type” of the present embodiment refers to the corresponding technique including the PCIe 4.0 specification version and the corresponding PCIe specification version disclosed after this version (such as PCIe 5.X, PCIe 6.X.. etc.) In other words, the embodiments of the disclosure are not limited to the contents of the PCIe 3.0 specification version and the PCIe 4.0 specification version, instead technical research and development are correspondingly carried out based on the differences in clock signals.

FIG. 1A shows a PCIe add-in card 110-1 of PCIe 3.0 type and a motherboard 120-1 in a computer system. The motherboard 120-1 has a PCIe slot 125-1. The pins (commonly known as gold fingers) on the PCIe add-in card 110-1 and the PCIe slot 125-1 both have two sides, which are called side A and side B here. The motherboard 120-1 and the PCIe slot 125-1 may be collectively referred to as a motherboard device.

PCIe 3.0 type selectively switches whether to provide a clock enable signal via a PRSNT#2 function of a pin terminal PIN_B17. Specifically, when the PCIe add-in card 110-1 is inserted into the PCIe slot 125-1, since a pin PINA1 and a pin PINB17 of the PCIe add-in card 110-1 are electrically coupled to each other, and a pin terminal PIN_A1 in the PCIe slot 125-1 is connected to the ground terminal, a hot plug detection logic 130-1 in the motherboard 120-1 may determine that the PCIe add-in card 110-1 is successfully inserted into the PCIe slot 125-1 based on whether the pin terminal PIN_B17 is connected to the ground terminal.

After the hot plug detection logic 130-1 confirms that the PCIe slot 125-1 is successfully inserted via the pin terminal PIN_B17, the processing logic on the motherboard 120-1 correspondingly enables the clock signal, and provides the clock enable signal to the PCIe add-in card 110-1, so that the PCIe add-in card 110-1 is in operation. A pin terminal PIN_B12 of PCIe 3.0 type is not connected or used and is marked as not applicable (N/A) in FIG. 1A.

FIG. 1B shows a PCIe add-in card 110-2 compliant with PCIe 4.0 type and a motherboard 120-2 in a computer system. The motherboard 120-2 and a PCIe slot 125-2 may be collectively referred to as a motherboard device. Compared with PCIe 3.0 type, in the PCIe add-in card 110-2 of PCIe 4.0 type, an additional clock request (CLKREQ#) function is added to the pin terminal PIN_B12 thereof. In detail, the clock request function is, a computer system (e.g., the motherboard 120-2 and the clock request logic 140) having the PCIe slot 125-2 communicate bidirectionally with the processing chip 150 in the PCIe add-in card 110-2 via the pin terminal PIN_B12, thereby adjusting the clock enable signal and selectively performing functions such as operation or power saving.

As a result, the function of enabling the clock signal in PCIe 3.0 type conflicts with the CLKREQ# function of PCIe 4.0 type. PCIe 3.0 type selectively switches whether to provide a clock enable signal via the PRSNT#2 function of the pin terminal PIN_B17. Compared with the CLKREQ# function of PCIe 4.0 type, PCIe 3.0 type may only decide whether to enable the clock signal to the PCIe add-in card 110-1 and has no power saving function. In other words, in addition to retaining the PRSNT#2 function of the pin terminal PIN_B17, PCIe 4.0 type also implements the CLKREQ# function at the pin terminal PIN_B1. The PCIe add-in card 110-2 and the motherboard 120-2 may communicate with each other based on the pin terminal PIN_B12 and achieve functions such as power saving by controlling the clock enable signal. In other words, the two connection methods mentioned above for clock enable signals cannot exist at the same time. If these two clock enable signals are implemented at the same time due to incorrect connection, unexpected issues such as abnormal operation of the PCIe add-in card occur.

Among the two types mentioned above, PCIe 3.0 and PCIe 4.0, since they implement functions related to clock enable signals via different pins (for example, PCIe 3.0 type is implemented based on the pin terminal PIN_B17; PCIe 4.0 type is implemented based on the pin terminal PIN_B12), it is necessary to design a motherboard and a corresponding computer system that may support both the above two types, or make PCIe 4.0 type forward compatible (that is, compatible with PCIe 3.0 type).

In an embodiment of the disclosure, a switching device and a corresponding controller are disposed in the motherboard device so that the motherboard device may determine the card type of the PCIe add-in card and control the switching device via a basic input output system (BIOS) or a hardware circuit (e.g., platform path controller (PCH), CPU, or embedded controller) in the computer system to decide whether to connect the clock enable signal to a specific pin terminal (such as the pin terminal PIN_B12), so as to allow the motherboard to support the clock enable signal of PCIe 3.0 type on the graphics card and the clock request function of PCIe 4.0, thereby smoothly solving the potential incompatibility between the graphics card and the motherboard. Various embodiments consistent with the disclosure are provided below as examples.

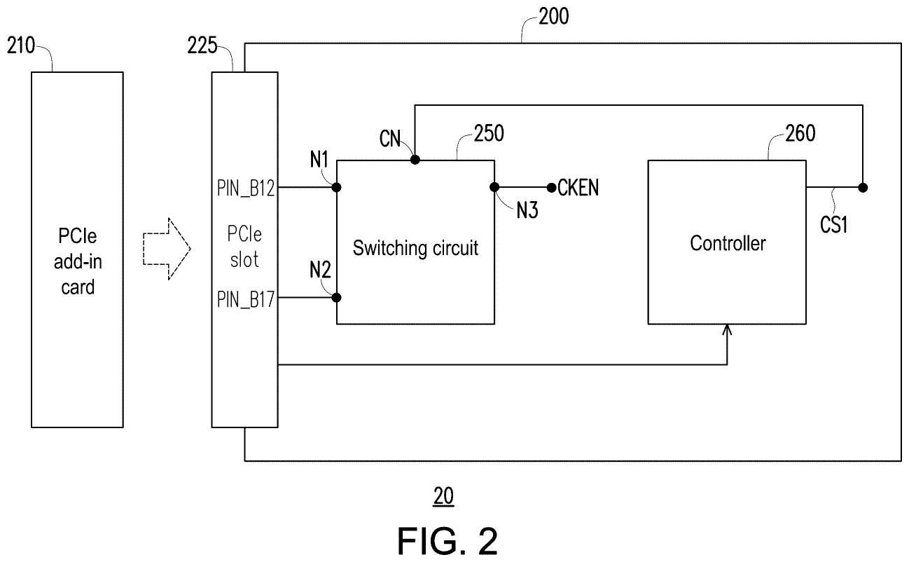

FIG. 2 is a block diagram of a computer device 20 according to an embodiment of the disclosure. The computer device 20 mainly includes a motherboard device 200, a PCIe add-in card 210, and other elements (such as a central processing unit, etc.) configured on the motherboard device 200. The motherboard device 200 includes a bus slot, a switching circuit 250, and a controller 260. The bus slot is, for example, a Peripheral Component Interconnect Express (PCIe) bus slot 225 (also referred to as a PCIe slot 225). The PCIe slot 225 includes the first pin terminal PIN_B12 and the second pin terminal PIN_B17. The first pin terminal PIN_B12 of the present embodiment is connected to the No. 12 pin terminal of the second side (e.g., side B) in the PCIe slot 225. The second pin terminal PIN_B17 is connected to the No. 17 pin terminal of the second side (side B) in the PCIe slot 255.

The switching circuit 250 includes a first terminal N1, a second terminal N2, a third terminal N3, and a control terminal CN. The first terminal N1 is coupled to the first pin terminal PIN_B12. The second terminal N2 is coupled to the second pin terminal PIN_B17. The third terminal N3 is coupled to the first terminal N1 and to a clock enable terminal CKEN. The clock enable terminal CKEN is configured to provide a clock enable signal.

The controller 260 provides a control signal CS1 to the control terminal CN of the switching circuit 250 according to the detection information of the bus slot. Specifically, the controller 260 is coupled to the PCIe slot 225 and to the control terminal CN of the switching circuit 250. The detection information of the bus slot may be the card type of PCIe add-in card configured in the PCIe slot, for example, the device identification code of the PCIe add-in card or the voltage signal on a specific pin terminal. The controller 260 determines whether the card type of the PCIe add-in card 210 is first PCIe type (e.g., PCIe 3.0 type) or second PCIe type (e.g., PCIe 4.0 type) via the PCIe slot 225 to provide the control signal CS1 to the control terminal CN, thereby selectively connecting the first terminal N1 to the third terminal N3 or connecting the second terminal N2 to the third terminal N3 in the switching circuit 250. The controller 260 of the present embodiment may be one of a BIOS, a platform path controller (PCH), a central processing unit, and an embedded controller, or a combination thereof.

Two states of the switching circuit 250 are described here: the connected state and the disconnected state. The switching circuit 250 is preset to the disconnected state. The disconnected state of the switching circuit 250 means that the first terminal N1 and the second terminal N2 in the switching circuit 250 are not connected to each other. Moreover, the first terminal N1 and the clock enable terminal CKEN are normally connected. It may be seen from FIG. 1B that the PCIe add-in card 110-2 of PCIe 4.0 type may not connect the first terminal N1 and the second terminal N2 in the switching circuit 250. In this way, the hot plug signal on the pin terminal PIN_B17 of a PCIe slot 120-2 and the clock request signal CLR_REQ on the pin terminal PIN_B12 of the PCIe slot 120-2 are not in conflict with each other. That is, the two signals are transmitted via different paths. In other words, in response to the controller 260 of FIG. 2 determining that the PCIe add-in card 210 is a PCIe add-in card (e.g., the PCIe add-in card 110-2 of FIG. 1B) of PCIe 4.0 type, the switching circuit 250 is turned off, that is, the switching circuit 250 is controlled to disconnect the first terminal N1 and the second terminal N2 thereof to not be connected to each other.

The connected state of the switching circuit 250 means that the first terminal N1 and the second terminal N2 in the switching circuit 250 are connected to each other, and the first terminal N1 and the clock enable terminal CKEN are normally connected. Therefore, in the switching circuit 250 in the connected state, the first terminal N1, the second terminal N2, and the third terminal N3 are at the same potential. In PCIe 3.0 type shown in FIG. 1A, the pin PINB17 of the PCIe add-in card 110-1 is electrically coupled to the pin PINA1. Moreover, after the PCIe add-in card 110-1 is inserted into the PCIe slot 120-1, the clock enable signal (i.e., the signal on a terminal GND of the PCIe slot 120-1) is electrically coupled to the pin terminal PIN_B17 of the PCIe slot 120-1 via the pin PINA1 and the pin PINB17 of the PCIe add-in card 110-1. Moreover, since the pin terminal PIN_B12 of the PCIe slot 120-1 is not applicable (N/A), no matter what the voltage on the pin terminal PIN_B12 is, the operation of the PCIe add-in card 110-1 is not affected. In other words, in response to the controller 260 of FIG. 2 determining that the PCIe add-in card 210 is a PCIe add-in card (e.g., the PCIe add-in card 110-1 of FIG. 1A) of PCIe 3.0 type, the switching circuit 250 is turned on, that is, the first terminal N1 and the second terminal N2 of the control switching circuit 250 are electrically connected to each other.

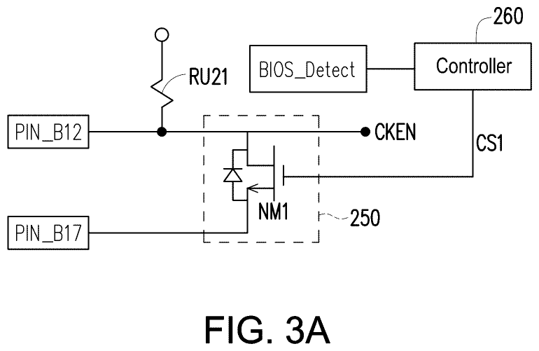

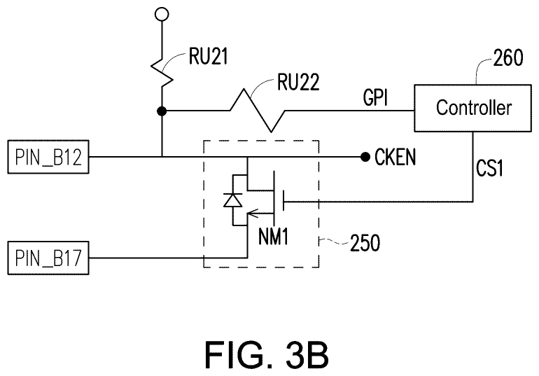

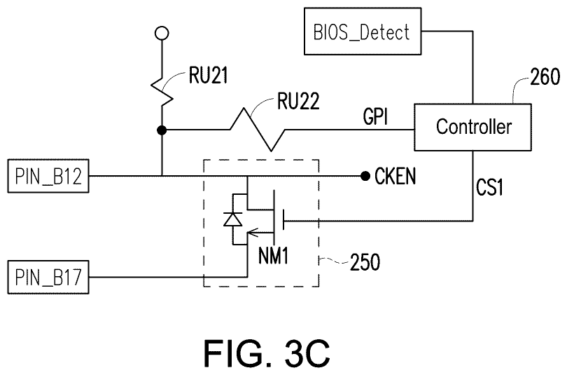

FIG. 3A to FIG. 3C are schematic diagrams of the switching circuit 250 and the controller 260 according to the first to third embodiments of the disclosure respectively. The switching circuits 250 in FIG. 3A to FIG. 3C are all implemented by an NMOS transistor NM1. The first terminal (e.g., the drain terminal) of the transistor NM1 is used as the first terminal N1 of the switching circuit 250. The second terminal (e.g., the source terminal) of the transistor NM1 is used as the second terminal N2 of the switching circuit 250. The gate terminal of the transistor NM1 is used as the control terminal CN of the switching circuit 250.

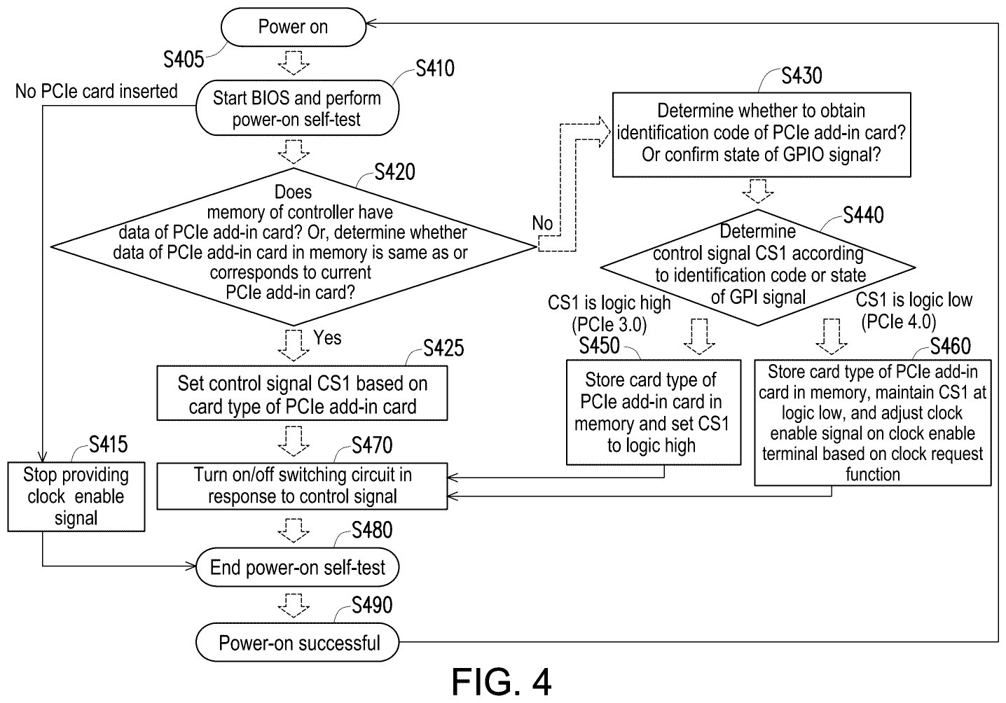

In FIG. 3A and the first embodiment, the controller 260 may identify the card type of the PCIe add-in card 210 via the device identification code of the PCIe add-in card 210. In addition to the first pin terminal PIN_B12 and the second pin terminal PIN_B17, the PCIe slot also includes pin terminals PIN_A13 and PIN_A14. The PIN_A13 and PIN_A14 pin terminals are defined in the PCIe specification as a reference clock differential pair signal REFCLK. The controller 260 may set the pin terminals PIN_A13 and PIN_A14 to start when the computer device is powered on and performs a power-on process, then, the relevant information of the PCIe add-in card 210 is obtained via detection by the BIOS, for example, the device identification code of the PCIe add-in card 210. In the present embodiment, the time point when the controller 260 performs the power-on process may include the power-on self-test of step S410 of FIG. 4. As shown in FIG. 3A, relevant information about the PCIe add-in card 210 is transmitted between the controller 260 of the present embodiment and the BIOS via a BIOS detection terminal BIOS_Detect. As a result, the controller 260 may determine whether the card type of the PCIe add-in card 210 is PCIe 3.0 or PCIe 4.0 via the device identification code of the PCIe add-in card 210, thereby selectively providing the control signal CS1 to the control terminal CN of the switching circuit 250.

Furthermore, the controller 260 may also include a corresponding memory, and the controller 260 stores the card type of the current PCIe add-in card 210 in the memory. If the computer system is turned on next time or the card type of the PCIe add-in card 210 needs to be determined, the controller 260 selectively provides the control signal CS1 to the control terminal CN of the switching circuit 250 based on the card type of the PCIe add-in card 210 stored in the memory.

In response to the card type of the PCIe add-in card 210 being PCIe 3.0 type, the controller 260 sets the control signal CS1 to logic high, thereby connecting the first terminal and the second terminal of the transistor NM1 in the control circuit 250 to each other, that is, the connected state of the control circuit 250 is entered. In contrast, in response to the card type of the PCIe add-in card 210 being PCIe 4.0 type, the controller 260 sets the control signal CS1 to logic low, thereby disconnecting the first terminal and the second terminal of the transistor NM1 in the control circuit 250, that is, the disconnected state of the control circuit 250 is entered.

The memory also has comparison information (for example, a comparison table) between the device identification code and the related PCIe type, so that after obtaining the device identification code of the PCIe add-in card 210, the controller 260 may learn the card type of the PCIe add-in card 210 via the comparison information (comparison table).

In FIG. 3B and the second embodiment, the controller 260 may identify the card type of the PCIe add-in card 210 via the voltage signal on the first pin terminal PIN_B12. It may be seen from FIG. 1A and FIG. 1B that the voltage signal on the first pin terminal PIN_B12 in FIG. 1A is not fixed. However, the voltage signal on the first pin terminal PIN_B12 in FIG. 1B is the clock request signal CLKREQ#, which is at a stable voltage level when the computer is first turned on. Therefore, in the present embodiment, the card type of the PCIe add-in card 210 may be determined by determining the voltage signal on the first terminal N1 of the switching circuit 250. In FIG. 3B, the controller 260 obtains the voltage signal on the first terminal N1 of the switching circuit 250 via impedance elements RU21 and RU22 and a terminal GPI, and then determines the card type of the PCIe add-in card 210. The operations of the switching circuit 250 and the controller 260 in FIG. 3B are the same as those in FIG. 3A. The difference between the two is that different methods are used to identify the card type of the PCIe add-in card 210.

FIG. 3C and the third embodiment integrate the methods of identifying the card type of the PCIe add-in card 210 in the first embodiment and the second embodiment. The controller 260 of FIG. 3C may set the reference clock differential pair signal REFCLK of PCIe to start when the computer device is turned on, then, the BIOS detects the device identification code of the PCIe add-in card 210 to determine the card type of the PCIe add-in card 210. The card type of the PCIe add-in card 210 may also be determined by obtaining the voltage signal on the first terminal N1 of the switching circuit 250. The operations of the switching circuit 250 and the controller 260 in FIG. 3C are the same as those in FIG. 3A and FIG. 3B. The difference between the three is that different methods are used to identify the card type of the PCIe add-in card 210.

FIG. 4 is a flowchart of a method for detecting an add-in card according to an embodiment of the disclosure. The detection method of FIG. 4 may be implemented by the computer devices of FIG. 2 and FIG. 3A to FIG. 3C. The detection method of FIG. 4 takes the BIOS in the computer device as the controller 260 of FIG. 2 as an example.

In step S405, the computer device is powered on and performs the power-on process. At this time, the controller (such as the BIOS) obtains a standby voltage Vaux and begins to start, and a system operating voltage Vss is gradually increased to stabilize the voltage value thereof. In step S410, the controller is started and starts a power-on self-test (POST) process. In the POST process, if it is determined that no PCIe add-in card is inserted into the PCIe slot, step S415 is performed from step S410, and the controller stops providing the clock enable signal to the PCIe slot.

In the POST process of the BIOS, the controller of the present embodiment determines the card type of PCIe add-in card currently configured in the PCIe slot (e.g., the PCIe slot 225 of FIG. 2). Moreover, the detection method of an embodiment of the disclosure is executed in response to the memory having no card type of PCIe add-in card currently configured in the PCIe slot 225, or in response to the data of the PCIe add-in card stored in the memory being different from the card type of PCIe add-in card currently configured in the PCIe slot 225.

Specifically, in step S420 of FIG. 4, the controller searches the memory thereof for relevant data of the PCIe add-in card, or, determines whether the data of the PCIe add-in card in the memory is the same as or corresponds to the current PCIe add-in card. The object of this step is to confirm whether an embodiment of the disclosure detects and stores the data of the PCIe add-in card to facilitate subsequent use. If there is no card type of PCIe add-in card currently configured in the PCIe slot 225 in the memory, or the data of the PCIe add-in card stored in the memory is different from the card type of PCIe add-in card currently configured in the PCIe slot 225, step S430 is entered from step S420.

If the memory of the controller already has the data of the PCIe add-in card, an embodiment of the disclosure also needs to determine whether the data of the PCIe add-in card in the memory is the same as or corresponds to the PCIe add-in card currently detected and interacted with the controller. The reason thereof is that the user may replace the PCIe add-in card of the PCIe slot in the computer device before powering on the computer or by a method of hot-plugging. Therefore, when step S420 is performed, to be stringent, in an embodiment of the disclosure, whether the corresponding information of the PCIe add-in card located on the PCIe slot is changed is still detected based on the corresponding data record (that is, the data of the PCIe add-in card) of its own memory via a controller (e.g., the BIOS).

If step S420 is yes, step S425 is entered from step S420, and the controller obtains the data of the PCIe add-in card based on the memory, and the data includes a device identification code. In step S425, the controller determines the card type of the PCIe add-in card based on above device identification code, and sets the control signal CS1 based on the card type of the PCIe add-in card.

If step S420 is negative, step S430 is entered from step S420. In step S430, the controller determines whether the identification code (as shown in FIG. 3A and the corresponding description) of the PCIe add-in card may be obtained from the BIOS detection terminal BIOS_Detect via detection by the BIOS to determine the card type of the PCIe add-in card, or the card type of the PCIe add-in card may be determined by confirming the state (as shown in FIG. 3B and the corresponding description) of the signal on the terminal GPI. In step S440, the controller determines the card type of the PCIe add-in card according to the device identification code or the state of the signal on the terminal GPI to determine whether the control signal CS1 is logic high or logic low.

Step S450 is when the control signal CS1 is logic high, indicating that the card type of the PCIe add-in card is PCIe 3.0. The controller stores the card type of the PCIe add-in card into the memory and sets CS1 to logic high.

Step S460 is when the control signal CS1 is logic low, indicating that the card type of the PCIe add-in card is PCIe 4.0. The controller stores the card type of the PCIe add-in card in the memory, sets CS1 to logic low, and adjusts the clock enable signal on the clock enable terminal CKEN based on the clock request function.

In step S470, the switching circuit is in the connected state (Turn on) or the disconnected state (Turn off) in response to the control signal set by the controller. After other portions of the POST process are finished running, the POST process is ended in step S480. After the POST process is completed, the computer device is successfully powered on in step S490.

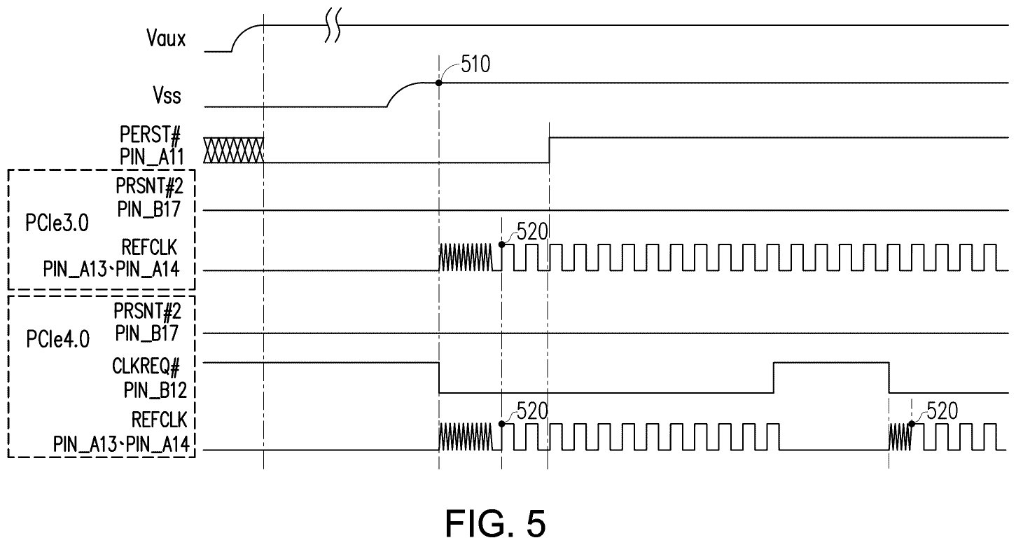

FIG. 5 is a timing diagram illustrating based on the signal waveforms in the PCIe specification of the JEDEC Solid State Technology Association according to an embodiment of the disclosure. JEDEC Solid State Technology Association is a standardization organization of the solid state and semiconductor industries. FIG. 5 presents in sequence the standby voltage Vaux, the system operating voltage Vss, a reset signal PERST# corresponding to the pin terminal PIN_A11, a hot plug detection signal PRSNT#2 corresponding to PCIe 3.0 type and located at the pin terminal PIN_B17, the reference clock signal REFCLK corresponding to PCIe 3.0 type and corresponding to the pin terminals PIN_A13 and PIN_A14, the hot plug detection signal PRSNT#2 corresponding to PCIe 4.0 type and located at the pin terminal PIN_B17, the clock request signal CLKREQ# corresponding to PCIe 4.0 type and located on the pin terminal PIN_B12, and the reference clock signal REFCLK corresponding to PCIe 4.0 type and located on the pin terminals PIN_A13 and PIN_A14. Corresponding to PCIe 3.0 type and earlier versions, the reference clock signal REFCLK on the pin terminals PIN_A13 and PIN_A14 continues to be output after the power supply is stabilized. Corresponding to PCIe 4.0 and later updated versions, the reference clock signal REFCLK on the pin terminal PIN_A13/A14 is controlled by the clock request signal CLKREQ# (the pin terminal PIN_B12). The system outputs the reference clock signal REFCLK (the pin terminals PIN_A13 and PIN_A14) when the CLKREQ# voltage level is pulled low, and stops outputting the reference clock signal REFCLK (the pin terminals PIN_A13 and PIN_A14) when the voltage level is pulled high.

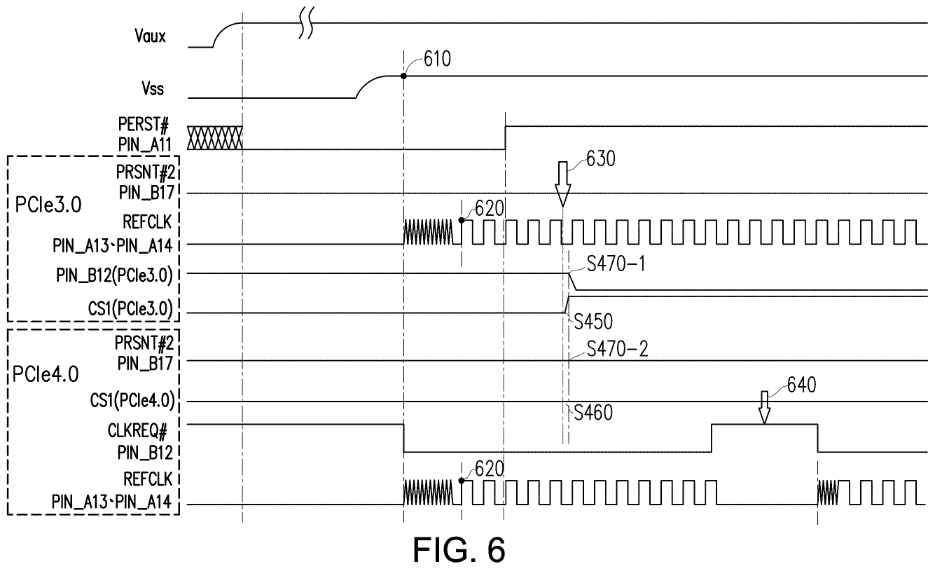

FIG. 6 is a diagram of each signal waveform in the detection method according to an embodiment of the disclosure. FIG. 6 shows the first pin terminal (PIN_B12) and the second pin terminal (PIN_B17) of the control signal related to the PCIe bus CLKREQ# to control whether the system sends the reference clock signal REFCLK (the pin terminals PIN_A13 and PIN_A14). At the same time, FIG. 6 also presents the working timing diagram of the control signal CS1 (PCIe 3.0) corresponding to PCIe 3.0 type and the control signal CS1 (PCIe 4.0) corresponding to PCIe 4.0 type.

Please refer to FIG. 5 and FIG. 6. Mark 510 and mark 610 indicate that the system operating voltage Vss is in a stable state and the detection method of FIG. 4 is started. Mark 520 and mark 620 indicate that when a PCIe add-in card of PCIe 3.0 type is inserted, the motherboard device starts to provide the reference clock signal REFCLK to the PCIe add-in card. Mark 630 of FIG. 6 indicates the time point when the controller determines the card type of the PCIe add-in card, i.e., the execution time point of step S425 and step S440 of FIG. 4. Mark 640 of FIG. 6 indicates that after the computer device is powered on, PCIe 4.0 type sets the PCIe add-in card in the power saving mode via the clock request signal CLKREQ#.

Mark S450 is used to represent the situation of step S450 of FIG. 4, that is, the controller determines that the card type of the PCIe add-in card is PCIe 3.0 type, and therefore sets the control signal CS1 to logic high. Mark S460 is used to represent the situation of step S460 of FIG. 4, that is, the controller determines that the card type of the PCIe add-in card is PCIe 4.0 type, and therefore maintains a control signal SCC1 set to logic low.

Mark S470-1 and mark S470-2 represent the situation of step S470 of FIG. 4. Mark S470-1 is that the control signal CS1 is set to logic high, so the switching circuit is in a connected state in response to the control signal CS1, that is, in the switching circuit 250, the first terminal N1 and the second terminal N2 are connected to each other, and the first terminal N1 and the clock enable terminal CKEN are normally connected. Mark S470-1 is that the control signal CS1 is set to logic low, so the switching circuit is in the disconnected state in response to the control signal CS1, that is, in the switching circuit 250, the first terminal N1 and the second terminal N2 are not connected to each other.

Based on the above, via the switching circuit and the detection information about the add-in card (such as card type detection of the add-in card), the motherboard device and the method for detecting the add-in card of the motherboard device of an embodiment of the disclosure selectively provide the corresponding signal (e.g., clock signal, clock request signal) of the add-in card to the correct pin terminal in different card types via the switching circuit. Therefore, in an embodiment of the disclosure, the motherboard device may smoothly support add-in cards of different bus types (such as PCIe add-in cards of PCIe 3.0 and PCIe 4.0), avoiding incompatibility between the motherboard device and the add-in card.

In other words, both types of graphics card standards are supported by the motherboard at the same time, the specific pins with conflicting functions are appropriately processed to achieve compatibility or switching needs of different versions of display cards. Based on the above, the issue of pin function conflicts between different PCIe versions of graphics cards during design of the motherboard manufacturers is solved in order to provide flexible compatibility.

What is claimed is:

1. A motherboard device, comprising:
a bus slot including a first pin terminal and a second pin terminal;
a switching circuit including a first terminal, a second terminal, a third terminal, and a control terminal, wherein the first terminal is coupled to the first pin terminal, the second terminal is coupled to the second pin terminal, the third terminal is coupled to the first terminal and to a clock enable terminal, and a clock enable signal is provided by the clock enable terminal; and
a controller coupled to the bus slot and the control terminal of the switching circuit, wherein a control signal is provided by the controller to the control terminal according to detection information of the bus slot, and the third terminal is selectively connected to the first terminal or to the second terminal in the switching circuit.

2. The motherboard device of claim 1, wherein the bus slot is a Peripheral Component Interconnect Express (PCIe) slot, and the detection information is indicative of a card type of a PCIe add-in card configured in the PCIe slot.

3. The motherboard device of claim 2, wherein the first pin terminal is connected to a No. 12 pin terminal of a second side in the PCIe slot, and the second pin terminal is connected to a No. 17 pin terminal of the second side in the PCIe slot.
The motherboard device of claim 1, wherein the switching circuit is preset to a disconnected state in which the first terminal and the second terminal in the switching circuit are not connected to each other.

5. The motherboard device of claim 2, wherein a device identification code of the PCIe add-in card is obtained by the controller from a basic input and output system (BIOS) via detection of the BIOS and the card type of the PCIe add-in card is determined according to the device identification code of the PCIe add-in card.

6. The motherboard device of claim 2, wherein the card type of the PCIe add-in card is determined by the controller by determining a voltage signal on the first terminal of the switching circuit.

7. The motherboard device of claim 2, wherein in response to the controller determining that the PCIe add-in card is a first PCIe type, the first terminal and the second terminal of the switching circuit are connected via the control signal, thereby connecting the second terminal to the third terminal in the switching circuit, and,
in response to the controller determining that the PCIe add-in card is a second PCIe type, the first terminal and the second terminal of the switching circuit are disconnected via the control signal, thereby connecting the first terminal and the third terminal in the switching circuit.

8. The motherboard device of claim 1, wherein the switching circuit further comprises:
a transistor, wherein a first terminal of the transistor is used as the first terminal of the switching circuit, a second terminal of the transistor is used as the second terminal of the switching circuit, and a gate terminal of the transistor is used as the control terminal of the switching circuit.

9. The motherboard device of claim 1, wherein the controller is one of a basic input and output system (BIOS), a platform path controller (PCH), a central processing unit, and an embedded controller, or a combination thereof.

10. The motherboard device of claim 2, further comprising:
a memory,
wherein the card type of the PCIe add-in card is stored by the controller in the memory, and
the control signal is provided by the controller to the control terminal of the switching circuit according to the card type of the PCIe add-in card stored in the memory.

11. A method for detecting an add-in card of a motherboard device, the method comprising:
determining detection information of a bus slot, wherein the bus slot includes a first pin terminal and a second pin terminal;
providing a corresponding control signal to a control terminal of a switching circuit via a controller according to the detection information, wherein the switching circuit includes a first terminal, a second terminal, a third terminal, and a control terminal, the first terminal is coupled to the first pin terminal, the second terminal is coupled to the second pin terminal, the third terminal is coupled to the first terminal and to a clock enable terminal, and a clock enable signal is provided by the clock enable terminal; and
the third terminal selectively being connected to the first terminal or t to the second terminal via the switching circuit according to the corresponding control signal.

12. The method for detecting the add-in card of claim 11, wherein the bus slot is a Peripheral Component Interconnect Express (PCIe) slot, and the detection information is indicative of a card type of a PCIe add-in card configured in the PCIe slot.

13. The method for detecting the add-in card of claim 12, wherein the first pin terminal is connected to a No. 12 pin terminal of a second side in the PCIe slot, and the second pin terminal is connected to a No. 17 pin terminal of the second side in the PCIe slot.

14. The method for detecting the add-in card of claim 11, wherein the switching circuit is preset to a disconnected state in which the first terminal and the second terminal in the switching circuit are not connected to each other.

15. The method for detecting the add-in card of claim 12, wherein the step of determining the card type of the PCIe add-in card configured in the PCIe slot comprises:
obtaining a device identification code of the PCIe add-in card from a basic input and output system (BIOS) via detection of the BIOS and determining the card type of the PCIe add-in card according to the device identification code of the PCIe add-in card.

16. The method for detecting the add-in card of claim 12, wherein the step of determining the card type of the PCIe add-in card configured in the PCIe slot comprises:
determining the card type of the PCIe add-in card by determining a voltage signal on the first terminal of the switching circuit.

17. The method for detecting the add-in card of claim 12, wherein the step of providing the corresponding control signal to the control terminal of the switching circuit via the controller according to the card type of the PCIe add-in card, and the third terminal is selectively connected to the first terminal or to the second terminal via the switching circuit according to the corresponding control signal comprises:
connecting the first terminal and the second terminal of the switching circuit via the control signal in response to the PCIe add-in card being a first PCIe type, thereby connecting the second terminal to the third terminal in the switching circuit; and
disconnecting the first terminal and the second terminal of the switching circuit via the control signal in response to the PCIe add-in card being a second PCIe type, thereby connecting the first terminal to the third terminal in the switching circuit.

18. The method for detecting the add-in card of claim 12, further comprising:
storing the card type of the PCIe add-in card in a memory; and
providing the control signal to the control terminal of the switching circuit based on the card type of the PCIe add-in card stored in the memory.

19. The method for detecting the add-in card of claim 18, further comprising:
determining the card type of the PCIe add-in card currently configured in the PCIe slot during a power-on self-test process of the basic input and output system (BIOS); and
executing the method in response to the memory having no card type of the PCIe add-in card currently configured in the PCIe slot or in response to data of a PCIe add-in card stored in the memory being different from the card type of the PCIe add-in card currently configured in the PCIe slot.

20. The method for detecting the add-in card of claim 19, further comprising:
stopping providing the clock enable signal in response to determining that no PCIe add-in card is configured in the PCIe slot during the power-on self-test process of the BIOS.
